(19) United States
(12) Patent Application Publication
(10) Pub. No.: US 2024/0367734 A1
(43) Pub. Date: Nov. 7, 2024

(54) TRACKED UNDERCARRIAGE FOR A TRACKED VEHICLE

(71) Applicant: CONTERNO & BONA S.R.L., MONFORTE D'ALBA (CN) (IT)

(72) Inventor: Federico Bona, MONFORTE D'ALBA (CN) (IT)

(21) Appl. No.: 18/688,615

(22) PCT Filed: Sep. 13, 2022
(86) PCT No.: PCT/IB2022/058607

§ 371 Date: Mar. 1, 2024

(30) Foreign Application Priority Data
Sep. 13, 2021 (IT) 102021000023585

(51) Int. Cl. B62D 55/10; B62D 55/125; B62D 55/14; B62D 55/24

(52) U.S. Cl. CPC B62D 55/10; B62D 55/125; B62D 55/14; B62D 55/24

(57) ABSTRACT

A tracked undercarriage for a tracked vehicle has an elongated structure; a first wheel rotatably mounted to the elongated structure at a first end of the elongated structure; a second wheel rotatably mounted to the elongated structure at a second end of the elongated structure; a track, which is looped around the first and second wheels and has an inner face configured to be arranged in contact with the first and second wheels and at least one protrusion of the cross-section extending from the inner face of the track and engaging respective spaces in the first and second wheels; and a track guide extending between the first and second wheels and configured to guide said protrusion as the track travels.

### CROSS-REFERENCE TO RELATED APPLICATIONS

This patent application claims priority from Italian patent application no. 102021000023585 filed on Sep. 13, 2021, the entire disclosure of which is incorporated herein by reference.

### TECHNICAL FIELD

The present invention concerns a tracked undercarriage for a tracked vehicle.

### BACKGROUND

The use of tracked vehicles is very widespread in the agricultural field for operating tools configured to work the ground or to eliminate insect pests or to weed the ground or to harvest. The use of tracked vehicles offers a better traction with respect to wheeled vehicles in particular when the vehicles operate on steep and precipitous grounds.

A tracked undercarriage generally comprises an elongated structure; a first wheel rotatably mounted to the elongated structure at a first end of the elongated structure; a second wheel rotatably mounted to the elongated structure at a second end of the elongated structure; and a track, which is looped around the first and second wheels and includes an inner face configured to be arranged in contact with the first and second wheels.

Generally, tracked vehicles are used on precipitous and uneven grounds, hence it can occur that the track subjected to strong external stresses fleets with respect to the first wheel and/or the second wheel, in particular, when the track is made of rubber.

### SUMMARY

An object of the present invention is to manufacture a tracked undercarriage capable of mitigating the drawbacks of the prior art.

In accordance with the present invention, a tracked undercarriage for a tracked vehicle is manufactured, the tracked undercarriage comprising:
an elongated structure;
a first wheel rotatably mounted to the elongated structure at a first end of the elongated structure;
a second wheel rotatably mounted to the elongated structure at a second end of the elongated structure;
a track, which is looped around the first and second wheels and includes an inner face configured to be arranged in contact with the first and second wheels and at least one protrusion of the cross-section extending from the inner face of the track and engaging respective spaces in the first and second wheels; and
a track guide extending between the first and second wheels and configured to guide said protrusion as the track travels along the path section of the track along which the track is in contact with the ground.

In this manner, the track guide prevents deformations of the track along the path section of the track along which it is in contact with the ground and where the track is subjected to high stresses.

In particular, the track guide comprises a plurality of elongated elements articulated with each other for allowing only deformations along planes perpendicular to the axes of the first and second wheels.

In this manner, the track guide is configured to prevent deformations of the track in directions parallel to the axes of the first and second wheels which could determine the fleeting of the track.

In particular, the track guide comprises a plurality of elongated elements of variable length for allowing the length variations of the track guide.

In particular, the opposite ends of the track guide are attached to the elongated structure so as to define a well-defined position of the track guide.

According to an embodiment of the present invention, the track guide comprises two elongated curved elements, each of which is attached to the elongated structure at the first and second wheels respectively so as to guide the track also at the first and second wheels.

In particular, the track comprises two protrusions of the cross-section, which are parallel to each other and extend from the inner face of the track. The two protrusions define a recess within which the track guide is slidably and dimensionally housed.

This solution simplifies the manufacturing of the track guide.

In accordance with an embodiment of the present invention, the first wheel comprises two first twin wheels arranged on opposite sides of the elongated structure and the second wheel comprises two second twin wheels arranged on opposite sides of the elongated structure, said track guide extending between the first and second twin wheels.

This configuration allows easily arranging the track guide also at the first and second wheels.

Furthermore, the two protrusions are configured to engage respective spaces between the first and second twin wheels and the track guide, hence at the first and second wheels the track is guided both from the first or the second wheel and from the track guide in a precise manner.

In accordance with an embodiment of the present invention the distance between the first and second wheels is selectively adjustable along the elongated structure for allowing calibrating the correct tension of the track and easing the replacement of the track.

In particular, the first and second wheels are made of rubber along the contact area with the track, which is also made of rubber so as to prevent the sliding between the track and the first and second wheels.

In accordance with an embodiment of the present invention, the track on one side and the first and second wheels on the other side have respective cross-sections shaped along the areas of mutual contact and at least partly complementary so as to further counter the risk of fleeting of the track.

In particular, the first wheel is a driving wheel and the second wheel is a deflection wheel.

In accordance with an embodiment of the present invention, the tracked undercarriage comprises a plurality of third wheels movably connected to the support structure and arranged in contact with the inner face of the track along the path section of the track along which it is arranged in contact with the ground.

In this manner, the track is also supported along the portion extending between the first and second wheels and is stressed by the underlying ground.

In particular, each third wheel comprises two third twin wheels arranged on opposite sides of the track guide so as not to interfere with the track guide.

In accordance with an embodiment of the present invention, the tracked undercarriage comprises a mechanical transmission, which is housed within the elongated structure and is configured to rotatably drive the first wheel.

In this manner, the undercarriage can be constrained to the frame of a tracked vehicle in any point and not necessarily at the axis of the driving wheel.

### BRIEF DESCRIPTION OF THE DRAWINGS

Further characteristics and advantages of the present invention will be clear from the following description of a non-limiting example embodiment thereof, with reference to the figures of the accompanying drawings, wherein:

FIG. 1 is a side elevation view, with parts removed for clarity, of a tracked undercarriage manufactured in accordance with the present invention;

FIG. 2 is a front elevation view, with parts removed for clarity, of the tracked undercarriage of FIG. 1;

FIG. 3 is a perspective view, with the track removed for clarity, of the tracked undercarriage of FIG. 1;

FIG. 4 is a section view, with parts removed for clarity, of the tracked undercarriage of FIG. 2 according to section lines IV-IV;

FIG. 5 is a section view, on an enlarged scale and with parts removed for clarity, of the tracked undercarriage of FIG. 1 according to section lines V-V; and

FIG. 6 is a perspective view, with parts removed for clarity, of a detail of the tracked undercarriage of FIG. 1.

### DESCRIPTION OF EMBODIMENTS

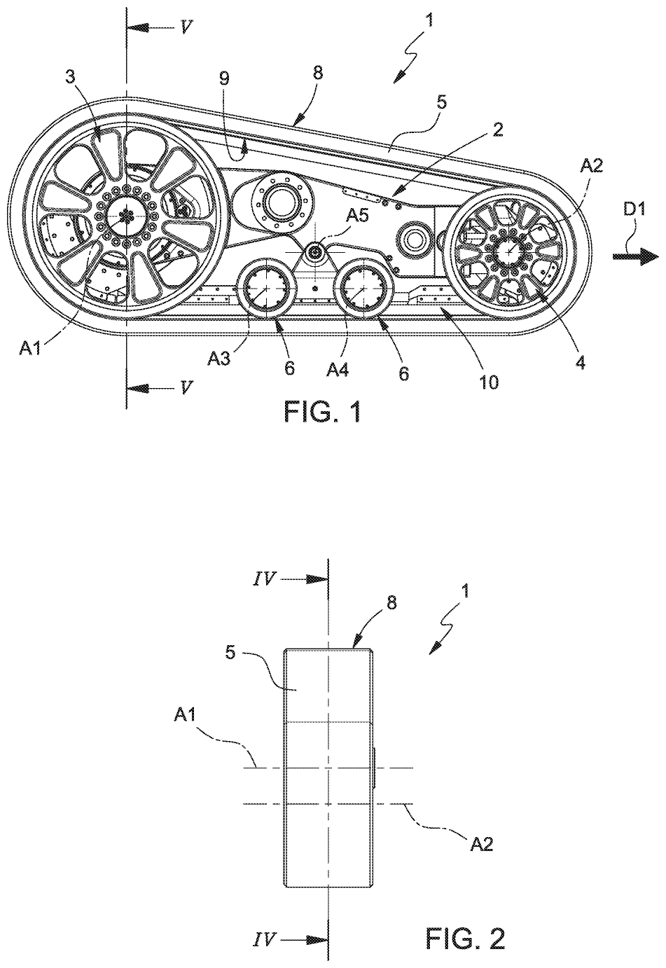

In FIGS. 1 and 2, reference numeral 1 indicates a tracked undercarriage 1, in particular for use in the agricultural field.

With reference to FIG. 1, the tracked undercarriage 1 is configured to mainly travel in a travel direction D1 although it can travel, when necessary, in reverse in the direction opposite the travel direction D1. The tracked undercarriage 1 comprises an elongated structure 2; a driving wheel 3 rotatably mounted around an axis A1 at an end of the elongated structure 2; a deflection wheel 4 rotatably mounted around an axis A2 at the other end of the elongated structure 2; and a track 5 looped around the driving wheel 3 and the deflection wheel 4.

The tracked undercarriage 1 comprises support wheels 6 which are arranged between the driving wheel 3 and the deflection wheel 4 along the path section of the track 5 in which it is arranged in contact with the ground. The support wheels 6 are wheels with a diameter sensibly less than the diameter of the driving wheel 3 and of the deflection wheel 4 and are movably supported by the elongated structure 2. In particular, the support wheels 6 are rotatably mounted around respective axes A3 and A4 on a rocker arm 7, which is articulated with the elongated structure 2 around an axis A5. The axes A1, A2, A3, A4 and A5 are parallel to each other.

The track 5 comprises an outer face 8 configured to be arranged in contact with the ground and an inner face configured to be arranged in contact with the driving wheel 3, the deflection wheel 4 and the support wheels 6. The track 5 is mainly made of rubber or at least the outer face 8 and the inner face 9 are made of rubber.

The tracked undercarriage 1 comprises a track guide 10 which extends between the driving wheel 3 and the deflection wheel 4 along the path section of the track 5 where the track 5 is in contact with the ground.

A pair of tracked undercarriages 1 is configured to be mounted to a frame of a tracked vehicle not illustrated in the accompanying figures.

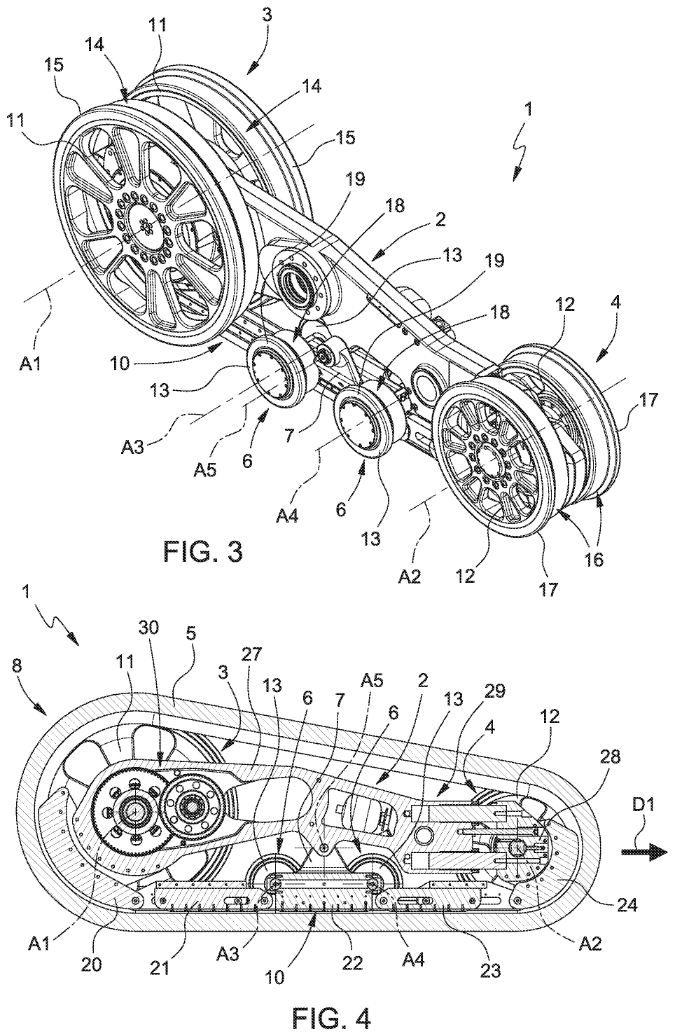

With reference to FIG. 3, the driving wheel 3 comprises a pair of twin driving wheels 11 arranged on opposite sides of the elongated structure 2. Similarly, the deflection wheel 4 and each support wheel 6 respectively comprise a pair of twin deflection wheels 12 arranged on opposite sides of the elongated structure 2 and a pair of twin support wheels 13 arranged on opposite sides of the rocker arm 7.

Each twin driving wheel 11 has an outer face 14 from which a lateral relief 15 projects. Similarly, each twin deflection wheel 12 has an outer face 16 and a lateral relief 17 and each twin support wheel 13 has an outer face 18 and a lateral relief 19. The outer faces 14, 16 and 18 are made of rubber.

With reference to FIGS. 4 and 6, the track guide 10 comprises a plurality of elongated elements 20, 21, 22, 23 and 24 articulated with each other around axes parallel to the axis A1.

With reference to FIG. 4, the elongated elements 21 and 23 are telescopically extensible, whereas the opposite ends of the track guide 10 are mounted and made integral with the elongated structure 2. In particular, the elongated elements 20 and 24 of the track guide 10 are curved, in this case arcs of a circle, and are respectively attached to the elongated structure 2 at the driving wheel 3 and at the deflection wheel 4 and have respective curvature centres that coincide with the axis A1 and the axis A2 respectively.

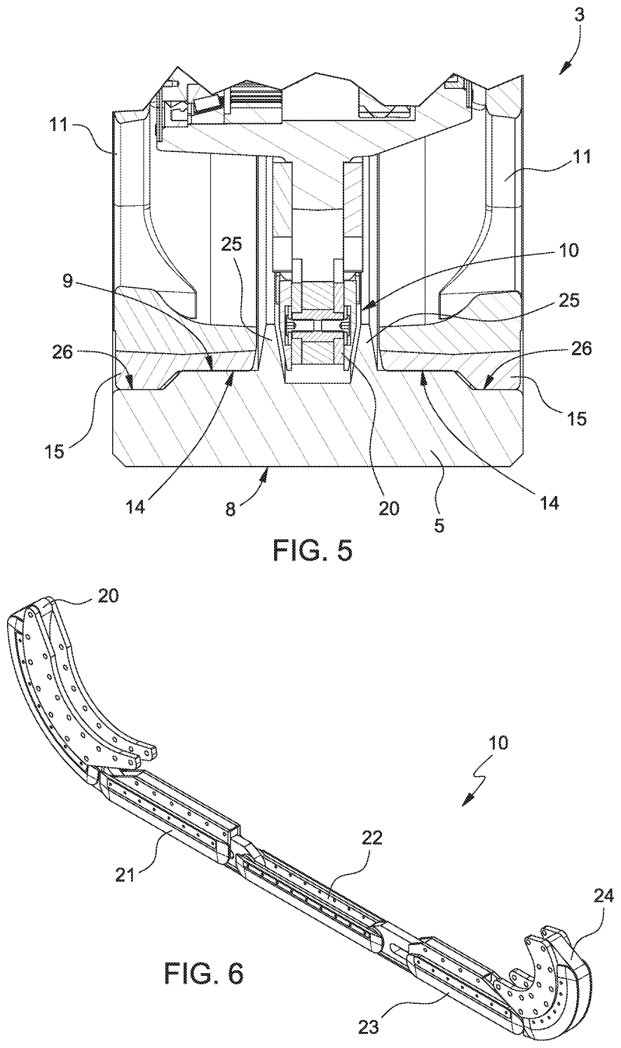

With reference to FIG. 5, the track 5 comprises two protrusions 25 of the cross-section, which are parallel to each other and extend from the inner face 9 and each is configured to engage respective spaces between the track guide 10 and the twin driving wheels 11.

The cross-section of the track 5 further has two lateral recesses 26 that allow making a shape coupling between the track 5 and the twin driving wheels 11. Since the twin driving wheels and the twin driven wheels have the same profile of the cross-section, a shape coupling is made similar to the one illustrated in FIG. 5 and the protrusions 25 of the track are housed in the spaces between the twin deflection wheels 12 and the track guide 10 and between the twin support wheels 13 and the track guide 10.

The track guide 10 occupies a space between the two protrusions 25 and defines a continuous guide along the entire path section of the track 5 along which the track 5 is arranged in contact with the ground.

With reference to FIG. 3, the distance between the driving wheel 3 and the deflection wheel 4 is selectively adjustable. In particular, the elongated structure 2 comprises two bodies 27 and 28 respectively coupled to the driving wheel 3 and to the deflection wheel 4 and selectively slidable with respect to each other by means of an actuator 29.

The tracked undercarriage 1 further comprises a mechanical transmission 30 housed within the body 27 and configured to drive the driving wheel 3. In use and with reference to FIG. 1, when the track 5 travels by means of the driving wheel 3 it is guided around the driving wheel 3 and the deflection wheel 4 and is mainly guided by the driving wheel 3 and, less, by the support wheels.

The track guide 10 guides in a continuous manner the track 5 along the entire path section along which the track is arranged in contact with the ground and receives greater stresses in all the directions including the directions parallel to the axes A1 and A2 in particular in the steering step. The stresses parallel to the axes A1 and A2 tend to fleet the track 5.

Furthermore, the track guide 10 allows the track 5 to deform in the directions transverse to the axes A1 and A2 and adapt to the profile of the ground.

The elongated structure 2 allows varying the distance between the driving wheel 3 and the deflection wheel 4 both for compensating the configurations of the track 5 and for allowing the replacement of the track 5.

It is finally evident that the present invention comprises variations of the described embodiment included within the scope of protection of the appended claims.

1. A tracked undercarriage for a tracked vehicle, the tracked undercarriage comprising:
an elongated structure;
a first wheel rotatably mounted to the elongated structure at a first end of the elongated structure;
a second wheel rotatably mounted to the elongated structure at a second end of the elongated structure;
a track, which is looped around the first and second wheels and includes an inner face configured to be arranged in contact with the first and second wheels and at least one protrusion of the cross-section extending from the inner face of the track and engaging respective slots in the first and second wheels; and
a track guide extending between the first and second wheels and configured to guide said protrusion as the track travels along the path section of the track along which the track is in contact with the ground.

2. The tracked undercarriage as claimed in claim 1, wherein the track guide comprises a plurality of elongated elements articulated with each other to allow only deformations along planes perpendicular to the axes of the first and second wheels.

3. The tracked undercarriage as claimed in claim 1, wherein the track guide comprises a plurality of elongated elements of variable length.

4. The tracked undercarriage as claimed in claim 1, wherein the opposite ends of the track guide are attached to the elongated structure.

5. The tracked undercarriage as claimed in claim 1, wherein the track guide comprises two elongated curved elements, each of which is attached to the elongated structure at the first and second wheels respectively.

6. The tracked undercarriage as claimed in claim 1, wherein the track comprises two protrusions of the cross-section, which are parallel to each other and extend from the inner face of the track.

7. The tracked undercarriage as claimed in claim 6, wherein the two protrusions define a recess within which the track guide is slidably and dimensionally housed.

8. The tracked undercarriage as claimed in claim 1, wherein the first wheel comprises two first twin wheels arranged on opposite sides of the elongated structure and the second wheel comprises two second twin wheels arranged on opposite sides of the elongated structure, said track guide extending between the first and second twin wheels.

9. The tracked undercarriage as claimed in claim 6, wherein the two protrusions are configured to engage respective spaces between the first and second twin wheels and the track guide.

10. The tracked undercarriage as claimed in claim 1, wherein the distance between the first and second wheels is selectively adjustable along the elongated structure.

11. The tracked undercarriage as claimed in claim 1, wherein the first and second wheels are made of rubber along the contact area with the track.

12. The tracked undercarriage as claimed in claim 1, wherein the track on one side and the first and second wheels on the other side have respective cross-sections shaped along the areas of mutual contact and at least partly complementary.

13. The tracked undercarriage as claimed in claim 1, wherein the first wheel is a driving wheel and the second wheel is preferably a deflection wheel.

14. The tracked undercarriage as claimed in claim 1, and comprising a plurality of third wheels movably connected to the support structure and arranged in contact with the inner face of the track along the path section of the track along which the track is arranged in contact with the ground.

15. The tracked undercarriage as claimed in claim 14, wherein each third wheel comprises two third twin wheels arranged on opposite sides of the track guide.

16. The tracked undercarriage as claimed in claim 1, and comprising a mechanical transmission, which is housed within the elongated structure and is configured to rotatably drive the first wheel.

17. The tracked undercarriage as claimed in claim 8, wherein the two protrusions are configured to engage respective spaces between the first and second twin wheels and the track guide.
